(19) United States
(12) Patent Application Publication
(10) Pub. No.: US 2026/0348475 A1
(43) Pub. Date: Nov. 5, 2026

(54) SHAFT SEAL STRUCTURE AND POWDER PROCESSING DEVICE

(71) Applicant: DALTON CORPORATION, Tokyo (JP)

(72) Inventors: Shoji Iwasaki, Tokyo (JP); Ichiro Koizumi, Tokyo (JP)

(73) Assignee: DALTON CORPORATION, Tokyo (JP)

(21) Appl. No.: 19/485,820

(22) PCT Filed: Feb. 26, 2024
(86) PCT No.: PCT/JP2024/006833

§ 371 Date: Nov. 19, 2025

(30) Foreign Application Priority Data
May 31, 2023 (JP) 2023-090095

(51) Int. Cl. F16J 15/44

(52) U.S. Cl. CPC F16J 15/441

(57) ABSTRACT

A shaft seal structure includes a case member, a shaft member, a bearing, and a cylindrical member having the shaft member inserted therein and provided in the vicinity of the bearing. The cylindrical member is held inside the case member in a displaceable manner relative to the case member. The cylindrical member is provided with a communication hole that allows an inner surface and an outer surface of the cylindrical member to communicate with each other. The communication hole allows gas to be introduced from outside to inside of the cylindrical member, and to be discharged to a side opposite to the bearing through a space between the inner surface of the cylindrical member and an outer surface of the shaft member, thereby forming a gap between the inner surface of the cylindrical member and the outer surface of the shaft member.

### TECHNICAL FIELD

The present invention relates to a shaft seal structure to be adopted in a powder processing device and the like.

### BACKGROUND ART

Conventional powder processing devices and the like have adopted a structure in which air is ejected from a gap between a fixed shaft seal component and a rotation shaft to prevent powder particles from entering a bearing member supporting the rotation shaft (see, Patent Literature (PTL) 1, for example).

### CITATION LIST

### Patent Literature

[PTL 1] Japanese Unexamined Patent Application Publication No. 2000-213652

### SUMMARY OF THE INVENTION

In conventional shaft seal structures, if a shaft diameter of a rotation shaft is fixed, volume of air used is determined by a dimension of a gap between a shaft seal component and the rotation shaft. The rotation shaft may vibrate due to its bending under the load during rotation or shaking of bearing components. In view of the above, if the air volume is controlled by reducing the dimension of the gap between the shaft seal component and the rotation shaft, a possibility of contact between the shaft seal component and the rotation shaft may increase.

The present invention was made in view of the above situation, and a purpose of the present invention is to provide a shaft seal structure and a powder processing device which allow the shaft seal component to move in conjunction with vibration of the shaft member for reducing the dimension of a gap between the shaft seal component and the rotation shaft without bringing them in contact with each other, thereby controlling the air volume.

Means to achieve the above purpose will be described hereinafter.

A shaft seal structure according to the present invention includes: a shaft case member; a shaft member that rotates inside the shaft case member; a bearing member that supports the shaft member inside the shaft case member; and a cylindrical member that has the shaft member inserted therethrough, and is provided in vicinity of the bearing member, in which the cylindrical member is held inside the shaft case member in a displaceable manner relative to the shaft case member, the cylindrical member is provided with a communication hole that allows an inner surface and an outer surface of the cylindrical member to communicate with each other, the communication hole allows gas to be introduced from outside to inside of the cylindrical member, and to be discharged to a side opposite to the bearing member through a space between the inner surface of the cylindrical member and an outer surface of the shaft member, thereby forming a gap between the inner surface of the cylindrical member and the outer surface of the shaft member, and preventing entry of a foreign substance toward the bearing member beyond the cylindrical member.

In the shaft seal structure, it is preferable that the cylindrical member is held by the shaft case member in a displaceable manner relative to the shaft case member with an elastic seal member interposed between each axial end face of the cylindrical member and the shaft case member.

In the shaft seal structure, it is preferable that a dimension of the gap between the outer surface of the shaft member and the inner surface of the cylindrical member is 0.01 mm or more and 0.1 mm or less.

In the shaft seal structure, it is preferable that the cylindrical member is provided with a plurality of communication holes along a circumferential direction of the cylindrical member, each of the communication holes being identical to the communication hole according to the above.

In the shaft seal structure, it is preferable that the inner surface of the cylindrical member is provided with a porous layer.

A powder processing device according to the present invention includes: the shaft seal structure according to any one of the above shaft seal structures; and a powder processing container provided on a side opposite to the bearing member relative to the cylindrical member in the shaft case member.

A powder processing device according to the present invention includes: the shaft seal structure according to any one of the above shaft seal structures, and another shaft seal structure identical to the shaft seal structure and facing the shaft seal structure; and a powder processing container provided between the shaft seal structures, in which the bearing member is provided on a side opposite to the powder processing container relative to the cylindrical member in each of the shaft structures, and the shaft member is shared in each of the shaft seal structures.

The shaft seal structure and the powder processing device according to the present invention enable the cylindrical member to move in conjunction with vibration of the shaft member. Accordingly, the air volume can be controlled by reducing a dimension of the gap between the cylindrical member and the rotation shaft without bringing them into contact.

### BRIEF DESCRIPTION OF THE DRAWINGS

FIG. 1 is a schematic cross-sectional view showing a powder processing device according to a first embodiment.

FIG. 2 is a perspective view showing a cylindrical member according to the first embodiment.

FIG. 3 is a cross-sectional view showing a shaft seal structure according to the first embodiment.

FIG. 4 is a schematic cross-sectional view showing a powder processing device according to a modified example of the first embodiment.

FIG. 5 is a schematic cross-sectional view showing a powder processing device according to a second embodiment.

FIG. 6 is a perspective view showing a cylindrical member according to the second embodiment.

FIG. 7 is a cross-sectional view showing a shaft seal structure according to the second embodiment.

### DESCRIPTION OF EMBODIMENTS

### Powder Processing Device 1 (First Embodiment)

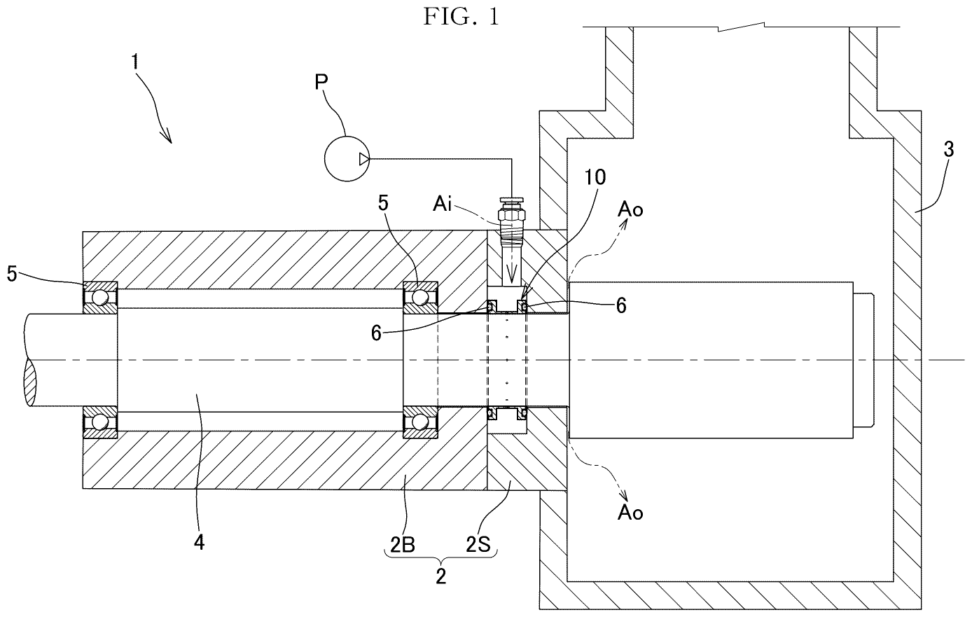

First, a powder processing device 1 that adopts a shaft seal structure according to the first embodiment of the present invention is described with reference to FIG. 1. The powder processing device 1 performs processing of powder used in pharmaceuticals and food products, and is configured with a shaft seal structure and a powder processing container 3. The powder processing device 1 performs one or more powder-related processes including drying, milling, particle classification, mixing, surface treatment, etc. Although the shaft seal structure is adopted in the powder processing device 1 in the present embodiment, usage to which the shaft seal structure of the present invention can be applied is not limited to the powder processing device 1. In other words, the shaft seal structure according to the present invention can also be adopted in other devices that may require a shaft seal structure.

As shown in FIG. 1, the shaft seal structure adopted in the powder processing device 1 includes a case member 2 serving as a shaft case member, a shaft member 4, a bearing 5 serving as a bearing member, a seal member 6, a cylindrical member 10, and an air pump P, for example. The shaft member 4 is connected to a motor (not shown) and rotates for the powder processing performed in the powder processing device 1. The case member 2 includes a bearing case 2B for housing the bearing 5 and a seal case 2S for housing the cylindrical member 10.

As shown in FIG. 1, the powder processing container 3 is provided on a side, which is opposite to the bearing 5 relative to the cylindrical member 10, in the case member 2. In the powder processing device 1, powder processing such as mixing is performed inside the powder processing container 3.

The shaft member 4 is rotatably supported inside the case member 2. Specifically, the shaft member 4 is supported by the bearing 5 provided inside the case member 2 (a bearing case 2B) so as to be rotatable inside the case member 2. One end of the shaft member 4 extends into an interior of the powder processing container 3 and is used for the processing of powder particles.

As shown in FIG. 1, the cylindrical member 10 is a stainless steel component into which the shaft member 4 is inserted and which is positioned in the vicinity of the bearing 5. In the present embodiment, a dimension of a space between an outer surface of the shaft member 4 and an inner surface of the cylindrical member 10 is set to be 0.01 mm or more and 0.1 mm or less, more preferably 5 μm to 100 μm.

In the powder processing device 1, a space provided with the cylindrical member 10 communicates with an air pump P, as shown in FIG. 1. Then, inflow air Ai indicated by an arrow pointing downward in FIG. 1 can be introduced around the cylindrical member 10 from the air pump P through an air supply port 21. Additionally, gases other than air, such as nitrogen, can also flow in the shaft seal structure according to the present invention.

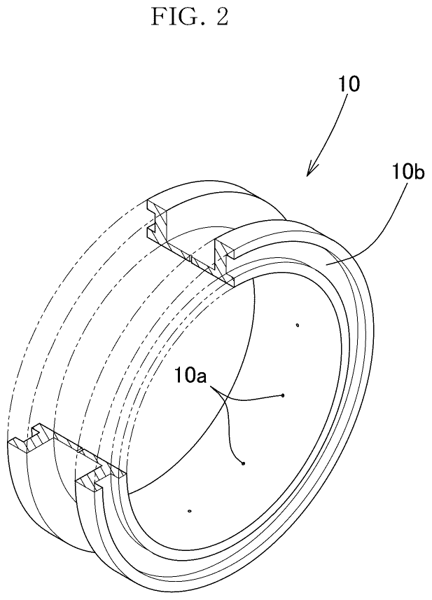

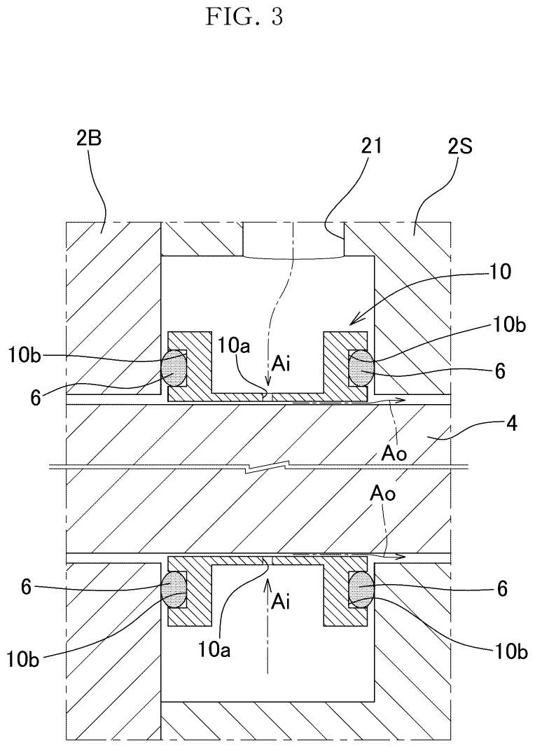

As shown in FIGS. 2 and 3, a plurality of communication holes 10a are provided on the cylindrical member 10 in its circumferential direction (in the present embodiment, 12 holes every 30 degrees) to allow the inner surface and outer surface of the cylindrical member 10 to communicate with each other. Through the plurality of communication holes 10a, the inflow air Ai delivered from the air pump P flows from the outer surface to the inner surface of the cylindrical member 10.

In the present embodiment, the communication holes 10a connect an outer peripheral surface and an inner peripheral surface of the cylindrical member 10. In the specification of the present application, the “inner surface” of the cylindrical member refers to the inner peripheral surface of the cylindrical member, and the “outer surface” of the cylindrical member refers to “all surfaces of the cylindrical member other than its inner peripheral surface” including the outer peripheral surface of the cylindrical member. In other words, in the shaft seal structure according to the present invention, it is also possible to provide a communication hole so that the inner peripheral surface of the cylindrical member and an axial end face of the cylindrical member are connected.

In the shaft seal structure adopted in the powder processing device 1, the cylindrical member 10 is held inside the case member 2 so as to be displaceable relative to the case member 2. Specifically, as shown in FIGS. 1 and 3, groove portions 10b are respectively formed on the axially opposite end faces of the cylindrical member 10. Seal members 6, which are O-rings having elasticity, are interposed between the respective groove portions 10b and the case member 2. This configuration allows the cylindrical member 10 to be displaceable relative to the case member 2 and the shaft member 4.

When the shaft seal structure is used in the powder processing device 1, the inflow air Ai is introduced from the outside to the inside of the cylindrical member 10 through the communication holes 10a, as shown in FIGS. 1 and 3. Then, outflow air Ao is discharged to a side, which is opposite to the bearing 5, of the case member 2, through the space between the inner surface of the cylindrical member 10 and the outer surface of the shaft member 4, as indicated by an arrow pointing rightward in FIGS. 1 and 3. This configuration prevents foreign substances such as powder particles from being introduced toward the bearing 5 beyond the cylindrical member 10.

As described above, gas (air in the present embodiment) flows between the inner surface of the cylindrical member 10 and the outer surface of the shaft member 4, thereby forming a gap between the inner surface of the cylindrical member 10 and the outer surface of the shaft member 4. At this point, the gap between the inner surface of the cylindrical member 10 and the outer surface of the shaft member 4 is maintained due to viscosity of the air. Furthermore, the cylindrical member 10 is held by the seal members 6 in a displaceable manner relative to the case member 2 and shaft member 4. With this configuration, even when the shaft member 4 vibrates, the cylindrical member 10 moves in conjunction with the shaft member 4.

This means that even if the shaft member 4 vibrates due to its high-speed rotation, contact between the inner surface of the cylindrical member 10 and the outer surface of the shaft member 4 can be prevented, in the present embodiment. Thus, according to the seal structure of the present embodiment, the cylindrical member 10 can move in conjunction with the shaft member 4, allowing a dimension of the gap between the outer surface of the shaft member 4 and the inner surface of the cylindrical member 10 to be set smaller than those in conventional structures. This enables volume of the air used to be reduced.

Furthermore, according to the shaft seal structure of the present embodiment, the volume of the air used is reduced, thereby achieving energy savings and at the same time decreasing an area of a filter for processing performed on the air blown into the interior of the powder processing device 1. Furthermore, exhaust volume can be reduced during vacuum drying when the interior of the powder processing device 1 is depressurized, reducing the capacity of a vacuum pump.

For example, if the gap between the inner surface of the cylindrical member 10 and the outer surface of the shaft member 4 is 20 μm, a shaft diameter of the shaft member 4 is 20 mm, and air flow velocity is 20 m/s, 1.5 L of air per minute is required. In conventional air-based shaft seal structures, a gap of approximately 0.5 mm is required between the shaft member and the shaft seal component, necessitating 38 L of air per minute. However, the shaft seal structure according to the present embodiment enables shaft sealing with approximately 1/25th of the air volume in comparison with the conventional shaft seal structures.

In the shaft seal structure of the present embodiment, the shaft sealing is performed with air, similar to a conventional air purge mechanism. Accordingly, the shaft seal structure of the present embodiment can be used even in devices where peripheral velocity of the shaft member 4 without contacting any component exceeds 10 meters per second. Additionally, an applicable range of the peripheral velocity for the shaft member 4 is 10 to 80 meters per second, while varying depending on the operating environment of the device. The gap between the inner surface of the cylindrical member 10 and the outer surface of the shaft member 4 can be set to 5 to 100 μm.

In the shaft seal structure of the present embodiment, the elastic O-rings are used as the seal members 6 to hold the cylindrical member 10 inside the case member 2 in a displaceable manner relative to the case member 2. Other configurations can be adopted as long as the cylindrical member 10 can be held in a displaceable manner relative to the case member 2. For example, it is also possible to adopt a configuration that uses contact seals with elasticity, such as oil seals or V-rings. Alternatively, the cylindrical member 10 may also be held in a displaceable manner relative to the case member 2 by circulating air around the cylindrical member 10 (the same applies to a modified example and a second embodiment described below).

### Powder Processing Device 1A (Modified Example of First Embodiment)

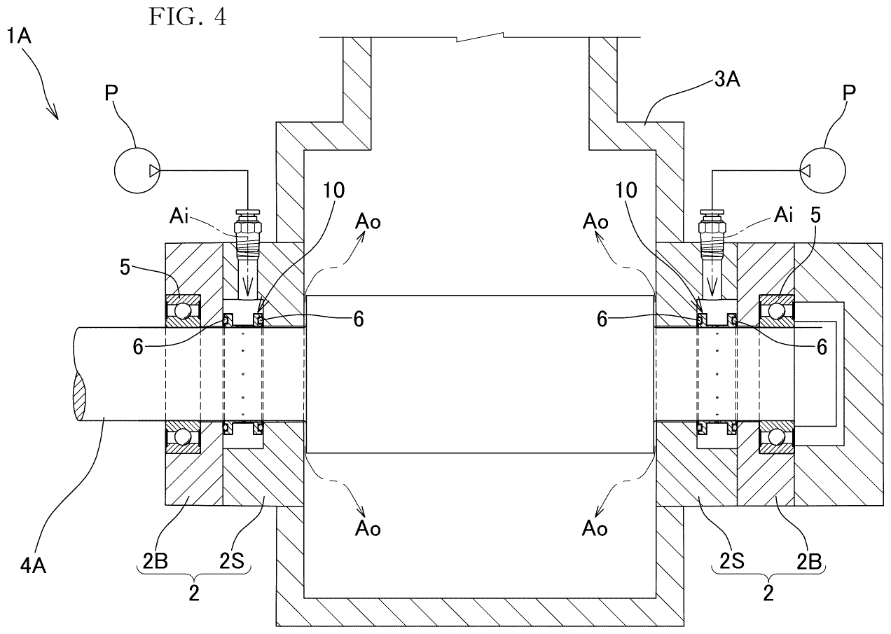

Next, a powder processing device 1A according to a modified example of the first embodiment will be described with reference to FIG. 4. The powder processing device 1A according to the modified example is configured similarly to the powder processing device 1, except that the shaft seal structures described in the first embodiment are arranged in a pair facing each other in the lateral direction. Thus, the same reference numerals are used for components identical to those in the powder processing device 1 of the first embodiment, and detailed descriptions of them are omitted in the following.

In the powder processing device 1A, a powder processing container 3A is provided between the respective shaft seal structures, as shown in FIG. 4. In each shaft seal structure, the bearing 5 is provided on a side opposite to the powder processing container 3A relative to the cylindrical member 10. In addition, a shaft member 4A is shared in the respective shaft seal structures.

When the respective shaft seal structures are used in the powder processing device 1A, the inflow air Ai is introduced from the outside to the inside of the cylindrical member 10 through the communication holes 10a, as indicated by an arrow pointing downward in FIG. 4. Then, as indicated by an arrow pointing inward in the powder processing container 3A in FIG. 4, the outflow air Ao is discharged to an opposite side of the cylindrical member 10 from the bearing 5 through a space between the inner surface of the cylindrical member 10 and the outer surface of the shaft member 4A. This configuration prevents foreign substances such as powder particles from being introduced outward (toward the bearing 5) beyond the cylindrical member 10.

In the modified example as well, gas (air in the present embodiment) flows between the inner surface of the cylindrical member 10 and the outer surface of the shaft member 4A, thereby causing a gap to form between the inner surface of the cylindrical member 10 and the outer surface of the shaft member 4A. At this point, the gap between the inner surface of the cylindrical member 10 and the outer surface of the shaft member 4A is maintained due to the viscosity of the air. Accordingly, even if the shaft member 4A vibrates, the cylindrical member 10 moves in conjunction with the shaft member 4A.

Specifically, even if the shaft member 4A vibrates due to its high-speed rotation, contact between the inner surface of the cylindrical member 10 and the outer surface of the shaft member 4A can be prevented in the modified example. Thus, in the seal structure adopted in the modified example, a dimension of the gap between the outer surface of the shaft member 4A and the inner surface of the cylindrical member 10 can also be set smaller than those of conventional structures, thereby reducing the volume of air used.

### Powder Processing Device 101 (Second Embodiment)

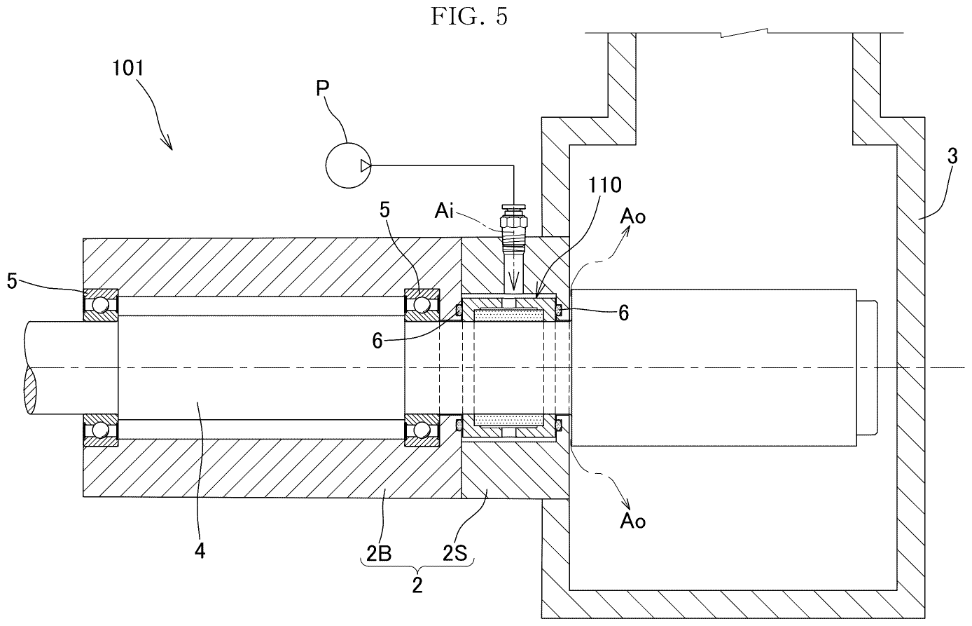

Next, a powder processing device 101 adopting the shaft seal structure according to the second embodiment of the present invention will be described with reference to FIG. 5. The powder processing device 101 according to the present embodiment is configured similarly to the powder processing device 1, except for the configuration of a cylindrical member 110, compared to the shaft seal structure described in the first embodiment. Thus, the same reference numerals are used for components identical to those in the powder processing device 1 of the first embodiment, and detailed descriptions of them are omitted in the following.

As shown in FIG. 1, the shaft seal structure adopted in the powder processing device 101 includes the case member 2 serving as a shaft case, the shaft member 4, the bearing 5 serving as a bearing member, the seal members 6, the cylindrical member 110, and the air pump P, for example. The case member 2 includes a bearing case 2B for housing the bearing 5 and a seal case 2S for housing the cylindrical member 110.

As shown in FIG. 5, the powder processing container 3 is provided on a side, which is opposite to the bearing 5 relative to the cylindrical member 110, in the case member 2. The shaft member 4 is supported in a rotatable manner inside the case member 2.

As shown in FIG. 5, the cylindrical member 110 is provided in the vicinity of the bearing 5 with the shaft member 4 inserted therethrough. In the present embodiment, a dimension of a gap between the outer surface of the shaft member 4 and the inner surface of the cylindrical member 110 is set to be 0.01 mm or more and 0.1 mm or less, more preferably 5 μm to 100 μm.

In the powder processing device 101, a space where the cylindrical member 110 is provided communicates with the air pump P, as shown in FIG. 5. The inflow air Ai indicated by an arrow pointing downward in FIG. 5 can be introduced around the cylindrical member 110 through the air supply port 21 from the air pump P.

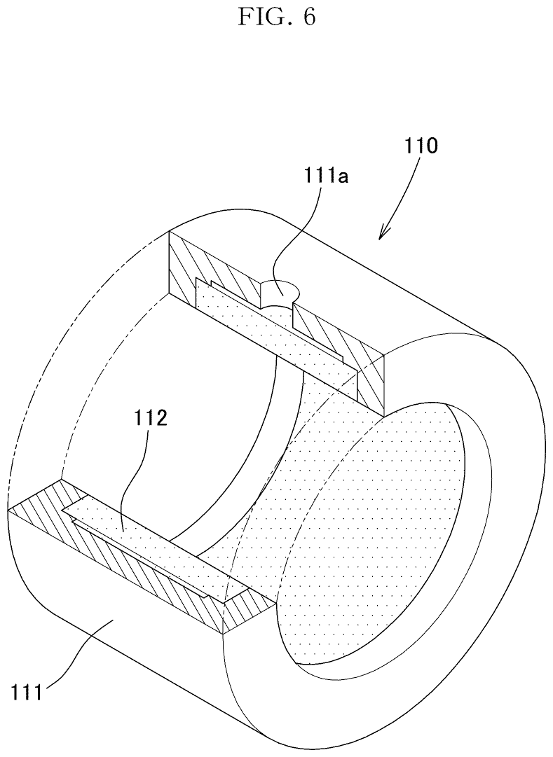

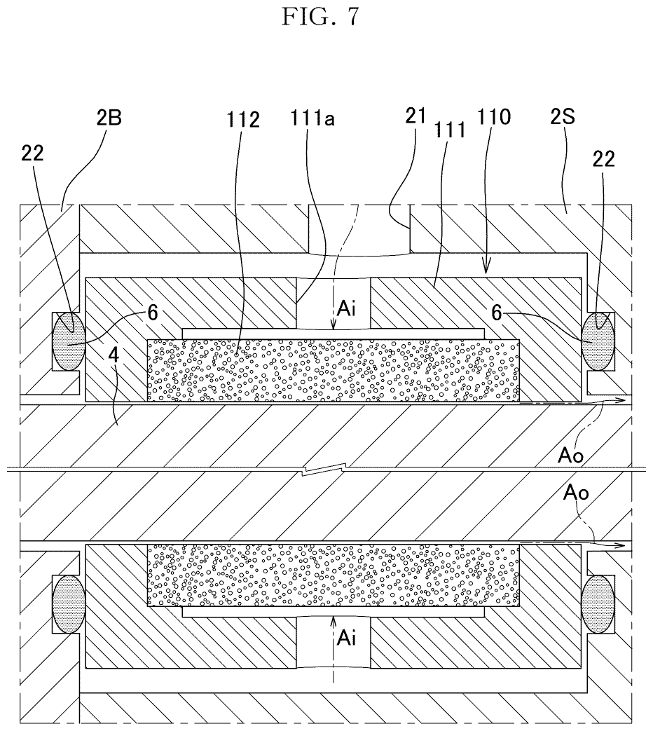

As shown in FIG. 6, the cylindrical member 110 is an air bearing including: an outer cylindrical portion 111 that is made of stainless steel and is exposed on an outer surface of the cylindrical member 110; and a porous layer 112 provided on an inner surface of the cylindrical member 110. As shown in FIGS. 6 and 7, communication holes 111a are provided in the outer cylindrical portion 111, and allow communication of the inner surface with the outer surface of the outer cylindrical portion 111. Furthermore, in the present embodiment, the porous layer 112 adopts a porous sintered alloy, thereby allowing air to flow therethrough. Thus, the inflow air Ai delivered from the air pump P flows from the outer surface to the inner surface of the cylindrical member 110.

In the shaft seal structure adopted in the powder processing device 101, the cylindrical member 110 is held in a displaceable manner relative to the case member 2 inside the case member 2. Specifically, as shown in FIGS. 5 and 7, the elastic O-ring seal member 6 is interposed between each of the axial end faces of the cylindrical member 110 and a groove portion 22 formed on a surface of the case member 2, the surface facing each axial end face of the cylindrical member 110. This configuration allows the cylindrical member 110 to be displaceable relative to the case member 2 and the shaft member 4.

When the shaft-seal structure is used in the powder processing device 101, the inflow air Ai is introduced from the outside to the inside of the cylindrical member 110 through the communication hole 111a and the porous layer 112, as shown in FIGS. 5 and 7. Then, as indicated by arrows pointing rightward in FIGS. 5 and 7, the outflow air Ao is discharged to an opposite side of the cylindrical member 110 from the bearing 5 through a space between the inner surface of the cylindrical member 110 and the outer surface of the shaft member 4. This configuration prevents foreign substances such as powder particles from being introduced toward the bearing 5 beyond the cylindrical member 110.

As described above, gas (air in the present embodiment) flows between the inner surface of the cylindrical member 110 and the outer surface of the shaft member 4, thereby forming a gap between the inner surface of the cylindrical member 110 and the outer surface of the shaft member 4. At this point, the gap between the inner surface of the cylindrical member 110 and the outer surface of the shaft member 4 is maintained due to the viscosity of the air. Therefore, even if the shaft member 4 vibrates, the cylindrical member 110 moves in conjunction with the shaft member 4.

In other words, even when the shaft member 4 vibrates due to its high-speed rotation, contact between the inner surface of the cylindrical member 110 and the outer surface of the shaft member 4 can also be prevented in the present embodiment. Thus, in the seal structure according to the present embodiment, it is possible to set a dimension of the gap between the outer surface of the shaft member 4 and the inner surface of the cylindrical member 110 smaller than those of conventional structures, thereby reducing the volume of the air used.

The present application is based on Japanese Patent Application No. 2023-090095 filed on May 31, 2023, and the contents thereof are included herein. The specific embodiments or examples described in the section of DESCRIPTION OF EMBODIMENTS for implementing the invention are intended solely to clarify the technical content of the present invention. The present invention should not be narrowly interpreted as being limited to such specific examples.

### INDUSTRIAL APPLICABILITY

The shaft seal structure and the powder processing device according to the present invention enable the cylindrical member to move in conjunction with vibration of the shaft member. Accordingly, the air volume can be controlled by reducing a dimension of the gap between the cylindrical member and the rotation shaft without bringing them into contact, thereby providing a useful solution.

### DESCRIPTION OF THE REFERENCE CHARACTERS

1 powder processing device (first embodiment)
1A powder processing device (modified example)
2 case member (case member for shaft member)
2B bearing case
2S seal case
3 powder processing container
3A powder processing container (modified example)
4 shaft member
4A shaft member (modified example)
5 bearing (bearing member)
6 O-ring (seal member)
10 cylindrical member
10a communication hole
10b groove
21 air supply hole
22 groove
101 powder processing device (second embodiment)
110 cylindrical member
111 outer cylindrical portion
111a communication hole
112 porous layer
Ai inflow air
Ao outflow air
P air pump

1. A shaft seal structure comprising:
a shaft case member;
a shaft member that rotates inside the shaft case member;
a bearing member that supports the shaft member inside the shaft case member; and
a cylindrical member that has the shaft member inserted therethrough, and is provided in vicinity of the bearing member, wherein
the cylindrical member is held inside the shaft case member in a displaceable manner relative to the shaft case member,
the cylindrical member is provided with a communication hole that allows an inner surface and an outer surface of the cylindrical member to communicate with each other,
the communication hole allows gas to be introduced from outside to inside of the cylindrical member, and to be discharged to a side opposite to the bearing member through a space between the inner surface of the cylindrical member and an outer surface of the shaft member, thereby forming a gap between the inner surface of the cylindrical member and the outer surface of the shaft member, and preventing entry of a foreign substance toward the bearing member beyond the cylindrical member.

2. The shaft seal structure according to claim 1, wherein
the cylindrical member is held by the shaft case member in a displaceable manner relative to the shaft case member with an elastic seal member interposed between each axial end face of the cylindrical member and the shaft case member.

3. The shaft seal structure according to claim 2, wherein
a dimension of the gap between the outer surface of the shaft member and the inner surface of the cylindrical member is 0.01 mm or more and 0.1 mm or less.

4. The shaft seal structure according to claim 2, wherein
the cylindrical member is provided with a plurality of communication holes along a circumferential direction of the cylindrical member, each of the communication holes being identical to the communication hole according to claim 1.

5. The shaft seal structure according to claim 2, wherein
the inner surface of the cylindrical member is provided with a porous layer.

6. A powder processing device comprising:
the shaft seal structure according to claim 1; and
a powder processing container provided on a side opposite to the bearing member relative to the cylindrical member in the shaft case member.

7. A powder processing device comprising:
the shaft seal structure according to claim 1, and another shaft seal structure identical to the shaft seal structure and facing the shaft seal structure; and
a powder processing container provided between the shaft seal structures, wherein
the bearing member is provided on a side opposite to the powder processing container relative to the cylindrical member in each of the shaft structures, and
the shaft member is shared in each of the shaft seal structures.
